(19) United States
(12) Patent Application Publication
(10) Pub. No.: US 2005/0251441 A1
(43) Pub. Date: Nov. 10, 2005

(54) Method of managing portable payment/charging modules usable in sales services

(75) Inventors: Ezio Arrigoni, Cerro Maggiore (IT); Carmela Spata, Cerro Maggiore (IT)

Correspondence Address: ROTHWELL, FIGG, ERNST & MANBECK, P.C., 1425 K STREET, N.W., SUITE 800, WASHINGTON, DC, 20005, US

(73) Assignee: Centro Della Comunicazione Interattiva S.p.A., Cerro Maggiore (IT)

(21) Appl. No.: 10/660,525

(22) Filed: Sep. 12, 2003

Related U.S. Application Data
(63) Continuation of application No. PCT/IT01/00130, filed on Mar. 14, 2001.

(51) Int. Cl. G06F 17/60

(52) U.S. Cl. 705/14; 705/26; 705/41

(57) ABSTRACT

A method of managing portable payment/charging cards usable by a plurality of consumers within the scope of a sales service selling products offered by a vendor comprises the steps of: —supplying a consumer of the said plurality with a portable payment/charging card, the card (CC) enabling the consumer to take advantage of benefits offered by the vendor within the scope of the sales service, —associating a current bank account with the vendor, the current account being divisible into a plurality of locations correlated with the consumers of the plurality, —crediting a monetary asset available to the consumer to a location of the plurality of locations which is correlated with the consumer (C), the card enabling the consumer to perform a plurality of financial transactions based on the asset and outside the sales service.

### FIELD OF THE INVENTION

The present invention relates to a method of managing payment/charging modules used within the scope of a sales service selling products offered by a vendor.

For the purposes of the present invention, the term “product” is intended to define goods and/or services of any type which are offered by a vendor and can be purchased or used by a consumer.

Moreover, the term “vendor” is intended to define any business or company which operates in the field of sales services in order to offer products to consumers.

In particular, the business may have exclusively the role of an intermediary between the producer and the consumer or may also have the role of a producer. For example, a supermarket retailing the product, a producer selling the product via the supermarket, a chain of businesses offering a restaurant service, a company selling services, or a company selling financial packages will be defined as the vendor.

### BACKGROUND OF THE INVENTION

Many vendors adopt the method of supplying the consumer with a portable payment and/or charging module (hereinafter referred to briefly as a portable payment/charging module) which enables the consumer to take advantage of some benefits or concessions within the scope of the sales service.

This module is generally constituted by a magnetic card or a card with an integrated circuit which stores a consumer identification code.

The consumer can deposit a sum of money at an authorized sales point of the vendor, “charging” or “prepaying” his magnetic card, that is, having the deposit recorded electronically by the vendor. After the magnetic card has been read and the consumer has been identified, the consumer can make payments at any of the vendor's sales points without having to use cash but with the use of the “electronic” credit which he enjoys with respect to the vendor as a result of the deposit.

Portable payment/charging cards are also used for the electronic recording of “points” or “coupons” which are representative of a monetary value correlated with a product offered and can be collected by the consumer by successive purchases of the product. The electronic recording permitted by the portable payment/charging modules has clear advantages over paper points or coupons.

These points or coupons, hereinafter referred to as bonus points, give the consumer the opportunity to enjoy discounts for subsequent purchases or the opportunity to claim gifts when a predetermined number of bonus points has been collected.

It has been observed that the use of portable payment/charging modules within the scope of a sales service establishes a bond of loyalty between the consumer and the vendor. In particular, the combination of the bonus points and the portable payment/charging module is an effective tool for the promotion of a new product.

However, it has been noted that conventional methods of managing portable payment/charging modules have some disadvantages.

Conventional methods in fact have in common that, regardless of whether the money has been deposited directly at a prepayment sales point or corresponds to bonus points collected, there is only a limited number of ways in which the consumer can make use of the money recorded electronically in his name.

In particular, as already stated, the payment/charging module can be used by the consumer exclusively for making purchases, with or without discount, or for claiming gifts from the same vendor.

### SUMMARY OF THE INVENTION

The object of the present invention is to propose a method of managing payment/charging modules which does not have the limitations and the disadvantages indicated above with reference to conventional methods.

The object of the present invention is achieved by a method of managing payment/charging modules as defined by claim 1.

### BRIEF DESCRIPTION OF THE DRAWINGS

Further characteristics and the advantages of the present invention will become clear from the following description of a preferred embodiment thereof, given by way of non-limiting example, with reference to the appended drawings, in which:

FIG. 1 is a diagram representing the method according to the invention, and FIG. 2 shows some steps of the method of FIG. 1 in greater detail and shows schematically a service centre and a credit institution which use the method of FIG. 1.

### DETAILED DESCRIPTION OF THE PREFERRED EMBODIMENT

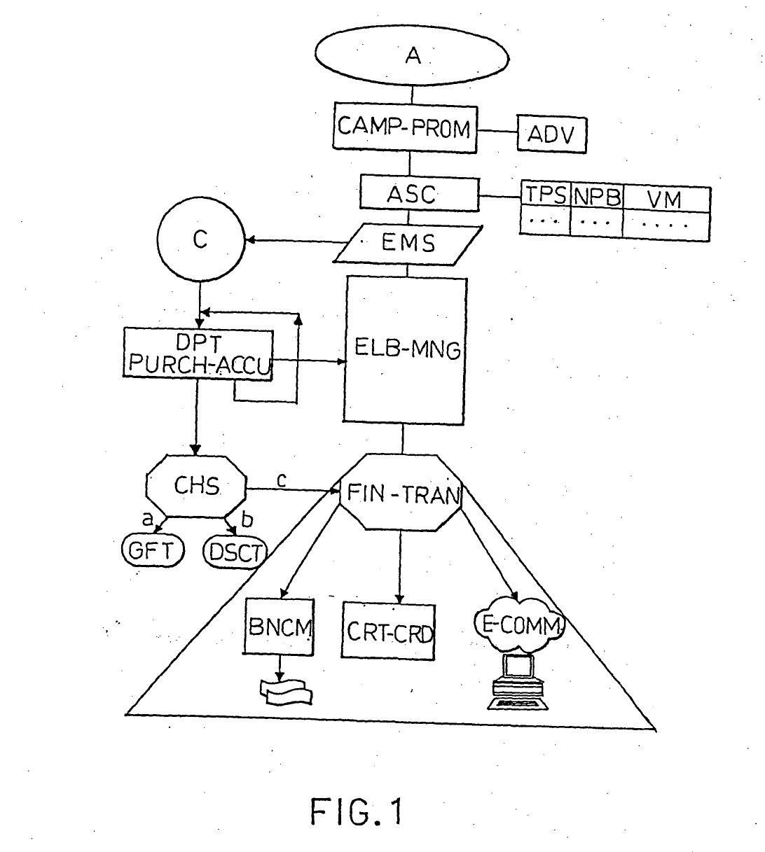

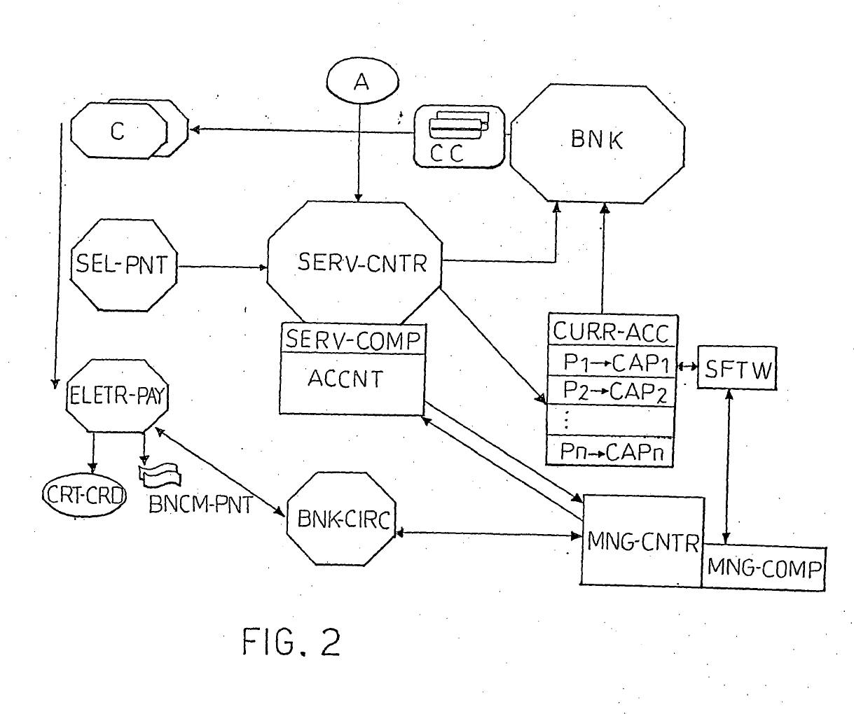

The method according to the invention is d scribed with reference to FIG. 1.

A company A having the above-defined role of vendor, undertakes a campaign CAMP-PROM to promote a predetermined product and a loyalty campaign with the purpose of establishing a relationship of loyalty between consumers and the company.

The promotion of the product and the loyalty campaign may, for example, make use of advertisements ADV.

The vendor A makes reference to a service centre, for example, a further company, which undertakes the management of the method according to the present invention.

Advantageously, at least one service computer is associated with the service centre and is in communication with a plurality of computers (for example, cash registers) present at a plurality of sales points connected to the company A.

The service centre enters into a suitable agreement with a credit institution. According to this agreement, a current bank account is created in the name of the service centre for association with the company A.

In particular, this single current account is subdivided structurally into a plurality of “locations” which can be associated with different consumers. A capital sum or monetary asset of each consumer can be credited to a respective location.

In other words, the single current account in the name of the service centre may be considered, from the point of view of its management, to comprise a plurality of “sub-current accounts” each of which is to be associated with a customer of the company A. The agreement entered into between the service centre and the credit institution may establish the costs of the management of the current account and provide for each sub-current account to have zero assets at the time of its creation, that is, to have a zero ceiling.

With regard to the credit institution, it should be noted that a management centre for managing the current bank account, provided with a management computer, is associated with this institution. Preferably, the management computer is in communication with the service computer by means of a suitable telematics network, and has means for storing data relating to the consumer and to the respective current bank account.

The method according to the invention also comprises an issuing step EMS in which a portable payment/charging module is supplied to the consumer C.

For example, this module is formed by a conventional magnetic card with a magnetic strip or a conventional chip card with an integrated circuit and, optionally, an integrated microprocessor. Portable modules produced by very different technologies such as, for example, cards similar to identity cards, or keys, may also be used.

The portable module is preferably formed by a magnetic card structurally similar to those used for the crediting of discount points in supermarkets. The following description will refer, by way of non-limiting example, to a magnetic card.

The magnetic card which can be acquired, for example, at a sales point of the company A, and which enables the consumer to be identified by the company, can be used by consumers to take advantage of benefits offered by the company A.

According to a particular embodiment of the present invention, in order to credit a predetermined amount of money to his location in the current account, the consumer can prepay or charge his magnetic card or collect bonus points.

In the first case (step DPT), the consumer can deposit a predetermined sum of money directly. In particular, the deposit may take place at any sales point of the company A authorized for this operation, or at an agreed bank of the credit institution. The deposit may also be made not only when the current account is created but also at a subsequent time.

Typically, the deposit presupposes a reading of the consumer's magnetic card. This reading is performed by a suitable device such as, for example, a conventional reader/writer with which a cash register is provided.

After the consumer has been identified, the computer associated with the reader/writer device sends data relating to the prepayment to the service centre's service computer. The service centre sends to the management computer an instruction to credit the money deposited by the consumer to the consumer's location in the current account.

If the deposit is performed at a bank, the deposit can take place by conventional methods. In this case, for example, the management centre of the credit institution will notify the service centre of the fact that a deposit has taken place and of the relevant data.

In the second case, that is, the collection of bonus points, at least one bonus point is associated with each product offered by the company A and is representative of a monetary value correlated with the product.

FIG. 1 shows schematically a table which represents the association step ASC, in accordance with which the corresponding number of bonus points NPB and the respective monetary value VM, for example, expressed in lire, is associated with each type of product TPS.

When the consumer purchases one or more products, bonus points are collected (step PURCH-ACCU) by the crediting of the monetary value of each bonus point to the consumer's location in the service centre's current bank account.

It is pointed out that the PURCH-ACCU step is iterative, that is, the collection of bonus-points is repeated upon each purchase of a product.

As explained with regard to the depositing of money at a sales point, this crediting method also provides for the reading of the magnetic card and the sending of a crediting instruction from the service processor to the management processor.

The magnetic card is such that it can store a consumer identification code and, optionally, information relating to the bonus points and to the consumer's assets.

The box ELAB-MNG of FIG. 1 summarises the functions performed by the service computer for the processing and management of the data relating to consumers, to the consumers'deposits, to the bonus points they collect, and to their assets.

FIG. 1 also shows, in a selection step CHS, three possible modes of operation or selections, a, b and c available to the consumer.

The consumer can select selections a and b, which lead to his use of the assets correlated with his location in the current account for operations within the sales service offered by the company A.

For example, these operations within the sales service comprise the purchase of other products (selection b), with or without discount DISCT or, when a predetermined number of bonus points has been collected, the opportunity to claim a gift GFT (selection a).

In addition to the above-mentioned operations, the consumer's magnetic card is advantageously also authorized to perform a plurality of financial transactions based on the consumer's assets and outside the sales service.

Some financial transactions available to the consumer as a result of selection c (FIN-TRAN step) such as, for example, any operation which can be performed by means of a cash dispenser or with a credit card, are indicated in FIG. 1.

In these cases, with the use of his magnetic card, the consumer can withdraw cash from a cash dispenser BNCM, or can make a payment at any sales point (even one which is not connected to the company A) which has an electronic payment system CRT-CRD.

Moreover, the consumer can use the assets present in the corresponding location of the current account to perform operations relating to electronic commerce ECOMM on the Internet (International Network) and can ask for his magnetic card to be debited.

With reference to these financial transactions, the agreement entered into between the company A and the credit institution may be such as to permit only financial transactions which involve a withdrawal or a payment of a value less than the consumer's assets.

It is pointed out that the present invention has the advantage that it enables the monetary value of the bonus points collected and/or the money deposited directly by prepayment of the magnetic card to be converted into money which can be utilized on financial electronic circuits.

It will be remembered that, according to the prior art, by prepaying or charging the magnetic card, the consumer can only make payments relative to the company with which the card is associated, or take advantage of discounts or obtain a bonus, again in relation to that company.

FIG. 2 is a block diagram which illustrates some steps of the method according to the invention in greater detail.

The block SERV-CNTR represents the service centre which has entered into the agreement with the credit institution BNK in order to manage the magnetic cards CC associated with the consumers of the firm As products.

The service centre SERV-CNTR's service computer, indicated by the block SERV-COMP, has storage means for storing data relating to the consumer's identity, to the bonus points, and to the current account associated with the company A. These storage means are represented by the block ACCNT.

The company A's current account, represented in FIG. 2 by a block CURR-ACC, is managed by the service centre SRV-CNTR and by the credit institution BNK's management centre MNG-CNTR.

The locations Pl-Pn to which separate assets CAP1-CAPn of a corresponding plurality of consumers can be credited can be distinguished in the current account CURR-ACC.

The credit institution BNK has an information technology data-bank or database in which the data relating to a plurality of consumers and to their assets are stored. The management centre MNG-CNTR comprises the management computer MNG-COMP which is provided, for example, with suitable accounting software SFTW for managing the current account CURR-ACC. The software SFTW ensures the balancing of the administrative, bookkeeping and taxation accounts.

Moreover, the service centre SERV-CNTR is in communication, for example, by means of the service computer SERV-COMP and a suitable telematics network, with the management centre MNG-CNTR and the credit institution BNK. In particular, the service center SERV-CNTR can send to/receive from the management center MGN-CNTR information and instructions relating to the current account CURR-ACC or instructions relating to financial transactions.

In FIG. 2, the arrows which connect the various blocks may represent either telematics connections between computers or organizational connections resulting from the agreements entered into. For example, the connecting arrow between the vendor A and the service centre SERV-CNTR represents the organizational link which exists between these two units and the connecting arrow between the service centre

SERV-CNTR and the credit institution BNK represents the existence of a suitable agreement.

As described with reference to FIG. 1, the magnetic card CC, which can be prepaid and recharged by the depositing of money or by the collection of bonus points, is supplied to each consumer.

The consumer C supplied with the magnetic card CC makes purchases at a sales point SEL-PNT, causing the monetary value of bonus points collected as a result of the purchase to be credited to his location (for example, PI) in the current account CURR-ACC, by means of the service centre SRV-CNTR.

The sales point SEL-PNT may also be authorized for the direct depositing of money by the consumer C, described above with reference to the step DPT. In another situation, the consumer C may deposit money in his location in the current account CURR-ACC at any bank authorized for this operation.

The opportunity for the consumer C to make a payment or a cash withdrawal is represented by a block ELETR-PAY which is put into communication by means of a bank circuit BNK-CIRC (for example, an international bank circuit which makes use of a suitable telematics network) with the management centre MNG-CNTR.

For example, it is assumed that the consumer wishes to perform a financial transaction such as a withdrawal from a cash dispenser BNCM.

The consumer inserts his magnetic card CC in a suitable slot of the reading device with which a computer associated with the cash dispenser BNCM-PNT is provided.

After a conventional recognition or identification step, the consumer C requests a predetermined sum of money.

This request is transmitted by the external computer, by means of the bank circuit BNK-CIRC, to the management centre MNG-CNTR's management computer MNGCOMP. In particular, the withdrawal request is encoded in a plurality of data which identify the financial transaction desired by the consumer C.

The management centre MNG-CNTR sends a request for authorization of the financial transaction to the service centre SERV-CNTR, together with the data relating to the consumer C and to the financial transaction.

The service centre SERV-CNTR's service computer SERV-COMP processes these data received, together with the data relating to the consumer C's assets (for example CAP1).

In particular, the service computer SRV-COMP compares the consumer C's assets CAP1 with the sum of money which the consumer wishes to withdraw.

According to one possible embodiment of the method according to the invention, the service computer SERVCOMP authorizes the financial transaction only if the consumer's assets are greater than the sum of money to be withdrawn.

If the financial transaction is considered acceptable, the service centre SERV-CNTR's service computer SERV-COMP sends an authorization signal to the management centre MNG-CNTR.

The management centre MNG-CNTR in turn sends instructions by means of the bank circuit BNK-CIRC to the computer associated with the cash dispenser BNCMPNT, enabling the consumer C to withdraw the money in cash. The management centre MNG-CNTR will update the data relating to the consumer C's assets deposited in a predetermined location in the current account CURR-ACC.

Naturally, for a financial transaction relating to a payment resulting from a purchase made by the consumer (a credit-card transaction CRT-CRD), the request for authorization of the payment takes place in a manner similar to that described above with reference to the cash-dispenser withdrawal.

It is pointed out that the method of the present invention affords considerable advantages to the consumer who is no longer forced to make use of the assets accumulated solely in a specific chain of sales points or for the purchase of products offered by a single company, but may have full availability of these assets. In parallel with the advantages offered to the consumer, the method described above reinforces a company's product-promotion or loyalty campaign. In fact, it is clear that, with the opportunities of the method proposed, the purchase of products offered by the company or the use of specific chains of sales points which use the method are particularly attractive to the consumer.

Naturally, in order to satisfy contingent and specific requirements, a person skilled in the art may apply to the above-described method of managing portable payment/charging modules many modifications and variations all of which, however, are included within the scope of protection of the invention as defined by the appended claims.

1. A method of managing portable payment/charging modules usable by a plurality of consumers within the scope of a sales service selling products offered by a vendor (A), the method comprising the steps of: —supplying (EMS) a consumer (C) of the said plurality with a portable payment/charging module (CC), the module (CC) enabling the consumer (C) to take advantage of benefits offered by the vendor (A) within the scope of the sales service, wherein it also comprises the steps of:
associating a current bank account (CURR-ACC) with the vendor, the current account being divisible into a plurality of locations (Pl-Pn) correlated with the consumers of the plurality,
crediting (DPT; PURCH-ACCU) a monetary asset (CAP1) available to the consumer to a location (PI) of the plurality of locations (Pl-Pn) which is correlated with the consumer (C), the module enabling the consumer to perform a plurality of financial transactions (FINTRAN) based on the asset and outside the sales service.

2. A method according to claim 1, in which the current bank account (CURR-ACC) is managed by a credit institution (BNK) cooperating with a service centre (SERV-CNTR) of a manager.

3. A method according to claim 2, in which the crediting step comprises a step of the depositing (DPT) by the consumer (C) of a sum of money in the location (PI) in the current account (CURR-ACC), the depositing step being performed at a sales point authorized by the vendor (SEL-PNT) or at a bank authorized by the credit institution (BNK).

4. A method according to claim 1, further comprising the steps of:
associating (ASC) with a product offered by the vendor at least one bonus point (NPB) representative of a monetary value (VM) correlated with the product,
upon the purchase of the product, crediting (PURCH-ACCU) the monetary value of the at least one bonus point to the location (PI) in the current account (CURR-ACC).

5. A method according to claim 1, in which the supply step comprises a step of the acquisition of the payment/charging module (CC) by the consumer (C).

6. A method according to claim 4 in which the portable module comprises means for storing an identification code of the consumer and information relating to the at least one bonus point and to the consumer's assets.

7. A method according to claim 1 in which the plurality of financial transactions comprises at least one financial transaction belonging to the group including: a cash-dispenser transaction (BNCM), a credit-card transaction (CRT-CRD), an Internet transaction (E-COMM).

8. A method according to claim 1 in which the benefits offered by the vendor within the scope of the sales service comprise at least one operation belonging to the group including: the purchase of a further product, the purchase of the further product with a discount (DISCT), the delivery of a gift (GFT).

9. A method according to claim 1 in which the portable module (CC) is of a type belonging to the group comprising: a magnetic card, a card with an integrated circuit, a card similar to an identity card, a key.

10. A method according to claim 3 in which, prior to the step of the depositing (DPT) of the sum of money or of the crediting (PURCH-ACCU) of the monetary value (VM), the consumer's assets (CAP1) are nil.

11. A method according to claim 2, in which a service computer (SERV-COMP) is associated with the service centre (SERV-CNTR) and a management centre (MNG-CNTR) using a management computer (MNG-COMP) is associated with the credit institution (BNK), the service computer and the management computer having respective means for storing data relating to the consumer and to the consumer's assets.

12. A method according to claim 11, in which the service computer (SERV-COMP) can exchange data/instructions with the management computer (MNG-COMP) by means of a telematics network.

13. A method according to claim 12, in which the crediting step (DPT; PURCH-ACCU) comprises a step of sending a datum/credit instruction from the service computer (SERV-COMP) to the management computer (MNG-COMP) by means of the telematics network.

14. A method according to claim 12, further comprising the step of:
receiving, in the management computer (MNG-COMP), a plurality of data relating to a financial transaction of the plurality of transactions (FIN-TRAN),
sending from the management computer to the service computer (SERV-COMP) a request for authorization of the financial transaction and the data relating to the financial transaction,
processing (ELB-MNG) the plurality of data relating to the transaction, together with the data relating to the consumer's assets, by the service computer (SERV-COMP),
supplying an authorization of the financial transaction by the service computer (SERV-COMP).

15. A method according to claim 14, in which the processing step (ELB-MNG) comprises a step of comparing the assets (CAP1) with a value of the withdrawal from the current bank account resulting from the financial transaction.

16. A method according to claim 15, in which the step of supplying an authorization of the financial transaction is performed only if the comparison step shows that the assets (CAP1) are greater than the value of the withdrawal.

17. A method according to claim 14, comprising, prior to. the step of receiving in the management computer, the steps of: operatively associating the portable identification module (CC) with an external computer (BNCM-PNT) in order to effect the financial transaction, the external computer being connected to the management computer (MNG-COMP) by means of a telematics network, sending the plurality of data relating to the financial transaction and the request for authorization of the financial transaction to the management computer (MNG-COMP), by the external computer (BNCM-PNT).

18. A method according to claim 14, further comprising a step of identification of the consumer performed by the management computer (MNG-COMP).
